(19) United States
(12) Patent Application Publication
(10) Pub. No.: US 2026/0356648 A1
(43) Pub. Date: Nov. 12, 2026

(54) FILLING NOZZLE AND REFILLING DEVICE WITH FILLING NOZZLE

(71) Applicant: ADA Cosmetics International GmbH, Kehl (DE)

(72) Inventors: Andreas PICKER, Strasbourg (FR); Christoph BELZ, Karlsruhe (DE)

(73) Assignee: ADA Cosmetics International GmbH, Kehl (DE)

(21) Appl. No.: 19/639,564

(22) Filed: Apr. 6, 2026

(30) Foreign Application Priority Data
May 9, 2025 (DE) 102025117970.0

(51) Int. Cl. B67C 3/26; B67C 3/28

(52) U.S. Cl. CPC B67C 3/26; B67C 3/28

(57) ABSTRACT

A filling nozzle for a refilling device for dosing dispensers, includes a pipe end piece having an external thread, and a screw sleeve, screwed onto the external thread in a cylindrical rear region, with a front region that at least partially covers the end face of the pipe end piece and a central opening that leaves a portion of the pipe cross-section free. The screw sleeve has a front-located, valve seat forming annular groove and/or an annular radial stop surface surrounding the central opening, to form an annular groove-shaped valve seat between itself and the annular end face of the pipe end piece. An integrally formed check valve includes a valve body for sealing the pipe end piece and/or the central opening, and an annular valve base inserted into the valve seat. The screw sleeve front region extends into a tubular collar that surrounds a majority of the valve body.

### CROSS-REFERENCE TO RELATED APPLICATIONS

This application claims priority from German Patent Application No. 10 2025 117 970.0, filed May 9, 2025, which is incorporated herein by reference as if fully set forth.

### TECHNICAL FIELD

The invention relates to a filling nozzle for a refilling device. The refilling device is intended for refilling dosing dispensers, which in turn hold liquid products, in particular detergent substances or personal care products, at the point of use and dispense them in measured doses as needed. The invention also relates to a corresponding refilling device for refilling dosing dispensers, as well as a refilling system that comprises, in addition to such a refilling device, a number of dosing dispensers.

### BACKGROUND

Dosing dispensers for the dosed dispensing of, in particular, detergent substances or personal care products have been known for a long time in various designs. They are used not only in private households, but also in hotels and in the restrooms of restaurants and similar public facilities, where they are sometimes provided in wall mounts or as free-standing units. In bathrooms and wellness areas of hotels, which are the preferred area of application for the present invention, dosing dispensers are often used not only for liquid soap, but above all for shower oils and gels, hair shampoo and conditioner, and other care products such as lotions or similar. The liquid products stored in them can be dosed as needed and removed in a hygienically safe manner without having to provide individually packaged and therefore unsustainable small containers of corresponding care products for one-time or two-time use.

In terms of the sustainable handling of resources, another major advantage of a dosing dispenser is that its container can be refilled. In hotels, the dosing dispensers to be refilled are usually collected, refilled centrally, and then distributed back to the places of use, in particular hotel rooms. Alternatively, the dosing dispenser is refilled on site as needed.

However, refilling dosing dispenser bottles can be time-consuming, especially in hotels where housekeeping staff are responsible for a large number of locations. This is because, traditionally, each dosing dispenser must be opened for the actual refilling process-in the case of a pump dispenser with a corresponding dispenser bottle, for example, the pump cap is unscrewed from the bottle neck-after which the liquid product to be refilled is first transferred from a storage tank to an intermediate container, and then the dispenser bottle or other container of the dosing dispenser must be refilled from this intermediate container through the open bottle or container opening. This is time-consuming and cumbersome, delays the housekeeping staff, and is therefore an unpopular task.

In addition, such a conventional refilling process is in need of improvement from a hygienic point of view, as the refilled liquid product does not remain in a closed system protected against contamination.

To avoid these problems, WO 2021/093972 A1 proposes a refill system with a number of specially designed pump dispensers and a refilling device, which makes the refill process much easier and, in particular, ensures that the refilled liquid product is largely protected against contamination during the refill process.

In order to design a refilling device for such a refilling system in such a way that a dosing dispenser designed as a pump dispenser can also be filled via its bottle neck—for which, of course, the dosing pump must first be removed—the refilling device must have a filling nozzle that is preferably oriented downward, so that the dispenser bottle of the dosing dispenser can be held underneath it for the refill process or, better yet, placed onto the filling nozzle.

However, if such a filling nozzle is arranged to point downward on the refilling device, the problem arises that after the refill process, once the dispenser bottle has been removed from the filling nozzle, a residual amount of liquid product may drip from the filling nozzle. This requires, particularly when the liquid product is a cosmetic product containing lipophilic or oil-based ingredients, increased cleaning effort, which should be avoided if possible.

Even with dosing dispensers that dispense the liquid product stored therein downward when pressure is applied to the container, such as those known from the applicant's EP 2 582 277, there is a risk of dripping. To prevent this, it is known to install a check valve in the downward-facing dispensing opening of the container; this valve is made in one piece from a soft, elastic material, such as a diaphragm or slot valve, and closes instantly as soon as the liquid product is no longer under pressure.

The problem with such soft-elastic valves is that, by their very nature, they are not very mechanically robust. If such a check valve is installed in a filling nozzle that is positioned downward-facing on the refilling device, there is a risk that the soft-elastic check valve can be easily damaged if a dosing dispenser or dispenser bottle is brought into contact with the filling nozzle carelessly.

The filling nozzle should therefore be designed in such a way that damage to the check valve is largely prevented and, furthermore, the check valve can be easily replaced.

### SUMMARY

Against this background, the invention addresses the problem of providing a filling nozzle for a refilling device which, even when mounted on the refilling device in a downward-facing orientation, does not drip and is nevertheless largely resistant to damage caused by careless handling.

This object is achieved by a device having one or more of the features disclosed herein. Preferred refinements of the filling nozzle according to the invention are described below in the description and claims that follow.

This object is furthermore achieved by a refilling device and by a refilling system having one or more of the features disclosed herein. Preferred refinements of the refilling system according to the invention are also described below.

A filling nozzle according to the present invention therefore comprises a pipe end piece with an annular radial end face and an external thread, as well as a screw sleeve designed to sit on the pipe end piece with a cylindrical rear region parallel to the axis. When the screw sleeve sits axially parallel on the pipe end piece, it at least partially covers the end face of the pipe end piece in axial projection with a front region. At the same time, however, it features a central opening that, in axial projection, leaves at least a portion of the pipe cross-section of the pipe end piece exposed. In principle, the screw sleeve is thus designed in the manner of a cap nut, but with a central opening in the bottom of the cap nut. In its rear region, the screw sleeve is provided with an internal thread for screwing onto the external thread of the pipe end piece; the screw sleeve thus not only sits parallel to the axis on the pipe end piece but is also screwed onto it. Inside its front region, the screw sleeve is provided with an annular groove to form a valve seat. Alternatively, to form a valve seat, a radial stop surface may be provided that surrounds the central opening, is annular in shape, and has an internal diameter that is smaller than the inner diameter of the internal thread, so as to form the annular groove-shaped valve seat between itself and the annular end face of the pipe end piece when the screw sleeve is screwed on. The aforementioned annular radial stop surface may also be formed as a groove wall of the annular groove or as a radial extension thereof.

As an alternative to the screw sleeve, the present invention may also provide a push-fit sleeve, in which case the pipe end piece has, instead of an external thread, a mating surface that is preferably circular-cylindrical in shape but may also assume other shapes, such as a conical shape or an elliptical cylindrical shape, and the like. In this alternative as well, the pipe end piece has an annular radial end face. The push-fit sleeve is designed to sit axially parallel on the pipe end piece with a rear region that is preferably cylindrical in shape and adapted to the mating surface. When the push-fit sleeve sits axially parallel on the pipe end piece, its front region at least partially covers the end face of the pipe end piece in axial projection. At the same time, however, it features a central opening that, in axial projection, leaves at least a portion of the pipe cross-section of the pipe end piece exposed. In principle, the push-fit sleeve is thus designed in the manner of a cap nut, but with a central opening in the bottom of the cap nut. At its rear end, the push-fit sleeve is equipped with an inner surface designed to fit onto the mating surface of the pipe end; the sleeve thus sits parallel to the axis on the pipe end. Inside its front region, the push-fit sleeve is provided with an annular groove to form a valve seat. Alternatively, to form a valve seat, a radial stop surface may be provided that surrounds the central opening, is annular in shape, and has an internal diameter that is smaller than the inner diameter of the inner surface, so as to form the annular groove-shaped valve seat between itself and the annular end face of the pipe end piece when the push-fit sleeve is pushed on. The aforementioned annular radial stop surface may also be formed as a groove wall of the annular groove or as a radial extension thereof.

The pipe cross-section of the pipe end piece and the central opening of the screw sleeve or the push-fit sleeve are closed by a check valve, which is integrally manufactured from a soft-elastic material and comprises a valve body for closing the pipe end piece and/or the central opening of the screw sleeve or push-fit sleeve, as well as an annular valve base formed integrally with this valve body for insertion into the valve seat. To facilitate the insertion of such a check valve into the valve seat, the interacting parts of the filling nozzle according to the invention are generally dimensioned such that, when the valve base is inserted into the valve seat, the valve body of the check valve protrudes beyond the screw sleeve or the push-fit sleeve, i.e., the check valve extends through the central opening of the screw sleeve or push-fit sleeve.

To largely prevent damage to the valve body, which protrudes beyond the screw sleeve or push-fit sleeve, the screw sleeve or push-fit sleeve extends in its front region into a tubular collar that surrounds at least a major portion of the valve body and protects it from damage. Should the valve body nevertheless be damaged, the present design of the filling nozzle according to the invention makes it easy to expose the valve seat by unscrewing the screw sleeve and removing it from the pipe end piece, so that the check valve can be easily removed and replaced. Similarly, the push-fit sleeve, if provided as an alternative to the screw sleeve, can be removed from the pipe end piece to expose the check valve.

Due to its design, the filling nozzle of the invention allows for advantageously simple cleaning, which greatly facilitates hygienic operation.

The tubular collar, and preferably the entire front region of the screw sleeve or push-fit sleeve, may taper conically along its outer circumference in a direction away from the pipe connection and, in particular, be shaped as a conical surface. This facilitates the fitting or placement of a dosing dispenser or a dispenser bottle onto or against the filling nozzle for the refilling process. It is particularly preferred that the conically tapered outer circumference of the screw sleeve or push-fit sleeve forms an insertion bevel in the manner of a mandrel for a dosing dispenser to be refilled, specifically a conical insertion bevel. This is particularly advantageous when the dimensions of the filling nozzle are adapted to the dimensions of the bottle neck of the dispenser bottles to be refilled, allowing a dispenser bottle to be fitted onto the filling nozzle with a near-perfect fit. Another advantage of this unique shape, however, is that bottles with different opening diameters (e.g., 24 mm, 28 mm, etc.) can be filled cleanly and without difficulty. In addition, it provides users with a centering aid for the dosing dispenser bottles without “clogging” them or creating excess pressure.

In this context in particular, it is advantageous if the rear region of the screw sleeve or push-fit sleeve forms, at least in some areas, a cylindrical outer surface intended for sliding a dosing dispenser to be refilled or its dispenser bottle onto it, and which may, for example, also consist of a number of partial surfaces distributed around the circumference. For precisely when the neck of a dispenser bottle is to be placed on the filling nozzle, a suitable dimensioning of the outer circumference of the screw sleeve or insert sleeve, the bottle neck can be fitted almost perfectly onto the screw sleeve or insert sleeve, for which the conical, preferably cone-shaped insertion bevel offers significant advantages.

In this context, it is also advantageous if the cylindrical outer surface of the screw sleeve, on the side opposite the insertion bevel, is delimited by an annular web that serves as an end stop for the dosing dispenser.

Especially when the dosing dispenser to be refilled is to be slid onto the filling nozzle as snugly as possible for the refilling process, it is advantageous if the conically tapering outer circumference of the screw sleeve or insert sleeve is provided with circumferentially distributed grooves or channels extending substantially in the axial direction, which preferably continue into the cylindrical outer surface. Such grooves or channels allow for air exchange and thus pressure equalization when the dosing dispenser or its dispenser bottle is slid onto the filling nozzle.

The check valve of the filling nozzle according to the invention may be made of silicone, LSR (liquid silicone rubber), or synthetic rubber; the choice of material depends not least on the properties of the liquid products to be refilled.

The valve body of the check valve preferably features a slot or cross-slot as the valve opening, sealed by soft-elastic sealing lips, wherein the sealing lips are inclined toward the slot or cross-slot in a direction away from the valve base to allow a liquid product regulated by the check valve to flow out through the slot or cross-slot once a predetermined threshold pressure is reached. The check valve may be designed as a lip valve, duckbill valve, or (cross) slot valve, as a dome-shaped valve with a slot, or as a silicone cross-slot valve (also known as a “ketchup diaphragm”).

The valve body of the check valve, which is part of the filling nozzle according to the invention, extends, particularly preferably on its side facing away from the valve opening, into a circumferential, radially outward-facing projection to form the valve base. Such a design can be particularly easily inserted into the valve seat and secured there.

The refilling device of the invention for refilling dosing dispensers for liquid products, in particular those containing surfactants or personal care products, is equipped with a filling nozzle of the invention and accordingly exhibits all of its advantages.

The refilling system of the invention, comprising a number of dosing dispensers for liquid products, in particular liquid products containing surfactants or personal care products, and a refilling device for refilling the dosing dispensers with liquid products is also equipped with a corresponding filling nozzle, so that the same advantages already described in connection with the filling nozzle of the invention are again present.

An advantageous further development of the refilling system of the invention consists in the fact that at least some of the dosing dispensers are provided with refillable dispenser bottles, each having a bottle neck with a predetermined inner diameter, wherein the outer surface of the rear region of the screw sleeve or push-fit sleeve and the inner diameter of the bottle neck are matched in such a way that the bottle neck can be pushed onto the rear region of the screw sleeve or push-fit sleeve, and the outer surface of the rear region of the screw sleeve or push-fit sleeve guides the bottle neck in the process. The dispenser bottle being refilled thus sits snugly or nearly snugly on the filling nozzle during the refilling process, so that there is no risk of accidental spillage of the refilled liquid product during the refilling process.

### BRIEF DESCRIPTION OF THE DRAWINGS

In the following, examples of a filling nozzle and a refilling system according to the invention are described and explained in more detail with reference to the accompanying drawings.

Since this is merely an example of a product according to the invention, the following descriptions are not to be understood as limiting the scope and extent of the present invention; nevertheless, features essential to the invention may be included in both the drawings and the description of the figures.

In the figures:

FIG. 1 is a schematic, isometric representation of an exemplary embodiment of a refilling device designed in accordance with the invention, during the refilling of a dosing dispenser;

FIG. 2 is a schematic sectional view of an exemplary embodiment of a filling nozzle according to the invention;

FIG. 3 is a schematic side view of a check valve from the filling nozzle shown in FIG. 2;

FIG. 4 is a cross-sectional view of a screw sleeve;

FIG. 5 is a schematic isometric view of the screw sleeve from FIG. 4;

FIG. 6 is a schematic isometric view of a push-fit sleeve of another embodiment, with a quick-release fastener;

FIG. 7 shows the quick-release fastener from FIG. 6;

FIG. 8 shows the push-fit sleeve from FIG. 6, viewed from a different direction.

### DETAILED DESCRIPTION

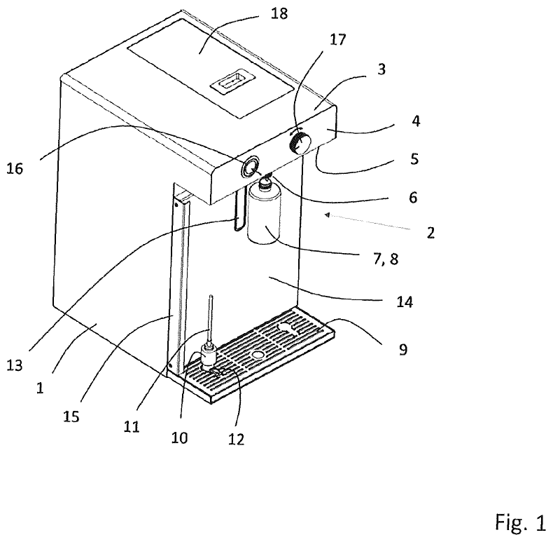

FIG. 1 is an isometric view from above, at an angle, of a refilling device designed according to the invention. The elements of this refilling device visible here are a housing 1 with a front side 2, a projection 3 in the upper region thereof with a front 4 and an underside 5. A filling nozzle 6 is arranged on the underside 5 of the projection 3 and serves to refill a dosing dispenser 7, more precisely: to refill a dispenser bottle 8 of a dosing dispenser 7.

On a drip tray 9, which is attached to the base of the front side 2 of the housing 1, a counterpart to the projection 3 is formed and serves primarily to collect liquid products that may have been spilled at the filling nozzle 6 or that drip from the filling nozzle 6, a shelf, which may also be designed as a holder, is formed for the components removed from the dispenser bottle 8 of the dosing dispenser 7 for the refilling process. These components are a dosing pump 10, which, as is known per se, is screwed into the dispenser bottle 8 of the dosing dispenser 7, an intake pipe 11 for the dosing pump 10, and a dispensing device 12, which is actuated by the dosing pump 10. These three components form a single, easily handled pump assembly, and because of the designated storage location on the drip tray, this assembly is placed on drip tray 9 for the refilling process, in the orientation shown here, which ensures the highest possible level of hygiene during refilling.

A flat light source 13 is mounted below the filling nozzle 6 on the front side 2 of the housing 1, the vertical extent of which corresponds approximately to the height of the dispenser bottle 8 to be refilled. A hinged door 14 with a handle strip 15 is used to open the front side 2 of the housing 1 in order to access or close off a compartment (not visible here) for a (not shown) refill container.

On the front 4 of the projection 3 of the housing 1 is a push button 16 for exiting standby mode and initiating rapid dispensing. A rotary control 17 allows for individual dosing of a quantity of refill liquid. A maintenance flap 18 is visible on the top side of the housing 1, under which a filling pump (not shown here) is located.

An operator who wishes to refill the dosing dispenser 7 will first switch the refilling device shown in FIG. 1 to the operating state and then unscrew the pump assembly of the dosing dispenser 7, consisting of the dosing pump 10, the intake pipe 11, and the dispensing device 12, from the dispenser bottle 8. The pump assembly 10, 11, 12 is then placed on the designated mark on the drip tray 9.

Switching on the refilling device also activates the light source 13. To refill the dispenser bottle 8 of the dosing dispenser 7, the operator holds the dispenser bottle 8 under the filling nozzle 6—or places the dispenser bottle 8 onto the filling nozzle, depending on its design. This places it directly in front of the light source 13. Since the dispenser bottle 8 in this example is made of translucent material and the light source 13 is positioned directly behind the dispenser bottle 8 as seen by the operator, illuminating it due to its translucency, the operator can clearly see the fill level of the liquid product in the dispenser bottle 8 through the transmitted light and thus monitor how quickly the refilling process is progressing and when the dispenser bottle 8 reaches the desired fill level.

The operator can control the refilling process using the rotary control 17. Overcoming an initial detent activates the filling pump, and turning the control knob 17 allows the operator to regulate the pump's flow rate, enabling them to initiate and perform the refill process very intuitively, monitor it via the transmitted light, slow it down in a timely manner, and stop it at the desired fill level.

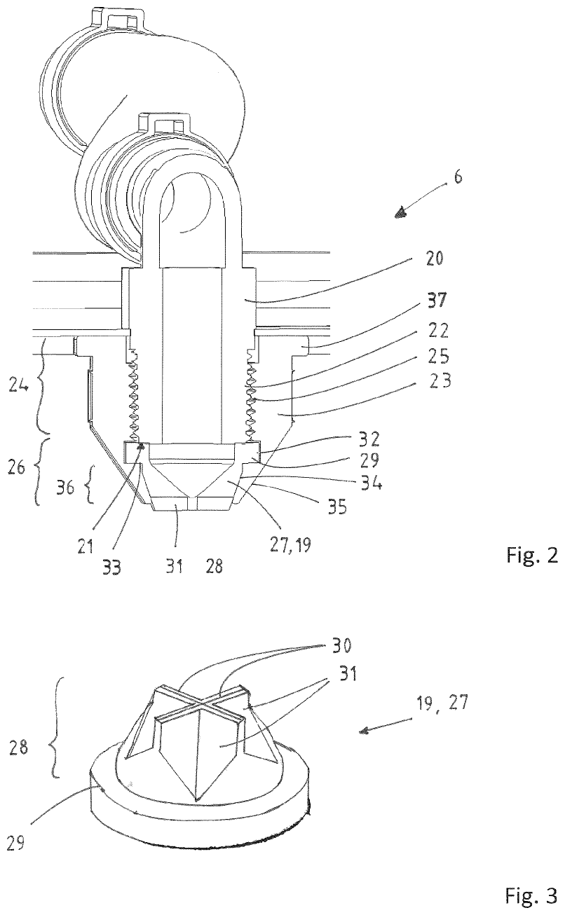

Once the refill process is complete, the pump assembly 10, 11, 12 is picked up again, screwed onto the dispenser bottle 8, and the dosing dispenser 7 is returned to its place of use. There is no risk of dripping at the filling nozzle 6, since, on the one hand, the filling nozzle 6 is equipped with a cross-slot valve 19 (FIGS. 2 and 3) and, secondly, the control system for the filling pump is designed such that after the filling pump is stopped, which is initiated by turning the control knob 17 back, a brief reverse movement of the filling pump occurs to relieve the pressure in a supply line (not shown here) leading to the filling nozzle 6. The drip tray 9 is only important in the event of careless operation of the refilling device; specifically, when the refill process is not stopped in time and liquid product from an overflowing dispenser bottle 8 reaches the filling nozzle 6 from the outside.

FIG. 2 shows a cross-section through the filling nozzle 6 of the refilling device from FIG. 1. This embodiment of a filling nozzle consists of a pipe end piece 20 with an annular, radial end face 21 and an external thread 22, as well as a screw sleeve 23, which has an internal thread 25 in a rear cylindrical region 24, with which it is screwed onto the external thread 22 of the pipe end piece 20. A check valve 27, designed as a cross-slot valve 19, is also located in a front region 26 of the screw sleeve 23.

The cross-slot valve 19 is more clearly visible in FIG. 3, where it is shown separately in a perspective view. This cross-slot valve 19 is a check valve 27 that is integrally manufactured from a soft-elastic material, in this case LSR silicone rubber. Such liquid silicone rubber (LSR) valves are typically manufactured using the LSR injection molding process. Alternatively, such cross-slot valves 19 are also compression-molded from silicone.

The cross-slot valve 19 consists of a valve body 28 and a valve base 29, the latter being ring-shaped and formed as a circumferential, radially outward-facing projection on the valve body 28.

A valve opening 30 of the cross-slot valve 19 is formed by two slots that are sealed by soft-elastic sealing lips 31. It is clearly evident that the sealing lips 31 have an inclination toward the respective slot or the valve opening 30 that points away from the valve base 29, in order to allow the fluid, regulated by the check valve 27, to flow out through the valve opening 30 once a predetermined threshold pressure is reached.

Returning to FIG. 2, in which the corresponding parts of the cross-slot valve 19 are designated with the same reference signs as in FIG. 3, it becomes clear that the valve base 29 sits in a valve seat 32 of the filling nozzle 6, wherein this valve seat 32 is formed in part between the end face 21 of the pipe end piece 20 and an annular radial stop surface 33 inside the front region 26 of the screw sleeve 32. As shown in FIG. 2, the diameter of this stop surface 33 is smaller than the inner diameter of the internal thread 25, so that the stop surface 33 forms an annular groove-shaped valve seat 32 between itself and the annular end face 21 of the pipe end piece 20. By screwing the screw sleeve 23 onto the pipe end piece 20, the valve base 29 is clamped in the valve seat 32, which ensures both a secure hold and a liquid-tight connection.

FIG. 2 also illustrates that, according to the invention, a screw sleeve 23 is designed such that its front region 26 at least partially covers the end face 21 of the pipe end piece 20 in axial projection and has a central opening 34, which, in axial projection, leaves the pipe cross-section of the pipe end piece 20 exposed and thus also allows the check valve 27 to pass through the screw sleeve 23 via the central opening 34, while sealing it due to the liquid-tight valve seat 32 when the valve opening 30 is closed. It is immediately apparent that when there is no longer any fluid pressure in the pipe end piece 20 and the cross-slot valve 19 closes its valve opening 30 due to the lack of pressure, dripping is reliably prevented.

Finally, FIG. 2 also shows that the rear region 24 of the screw sleeve 23 forms a cylindrical outer surface that serves to slide over the neck of the dosing dispenser 7 to be refilled (FIG. 1). This sliding on is facilitated by a conical surface 35 in the front region 26 of the screw sleeve 23, since the conical surface 35, as is immediately apparent, forms an insertion bevel in the manner of a mandrel for the bottle neck of the dosing dispenser 7.

At the same time, this conically tapering front region 26 of the screw sleeve 23 is formed as a tubular collar 36 that extends well beyond the valve seat 32 and surrounds a major portion of the valve body 28 of the cross-slot valve 19. This protects the cross-slot valve 19 (or another check valve 27, e.g., a duckbill valve) from damage even if the dispenser bottle 8 of the dosing dispenser 7 is carelessly placed onto the filling nozzle 6.

The cylindrical outer surface of the rear region 24 of the screw sleeve 23, which may also be composed of individual, circumferentially distributed sub-surfaces, is delimited on the side of the screw sleeve 23 facing away from the check valve 27 by an annular web 37, which serves as an end stop for the dosing dispenser 7.

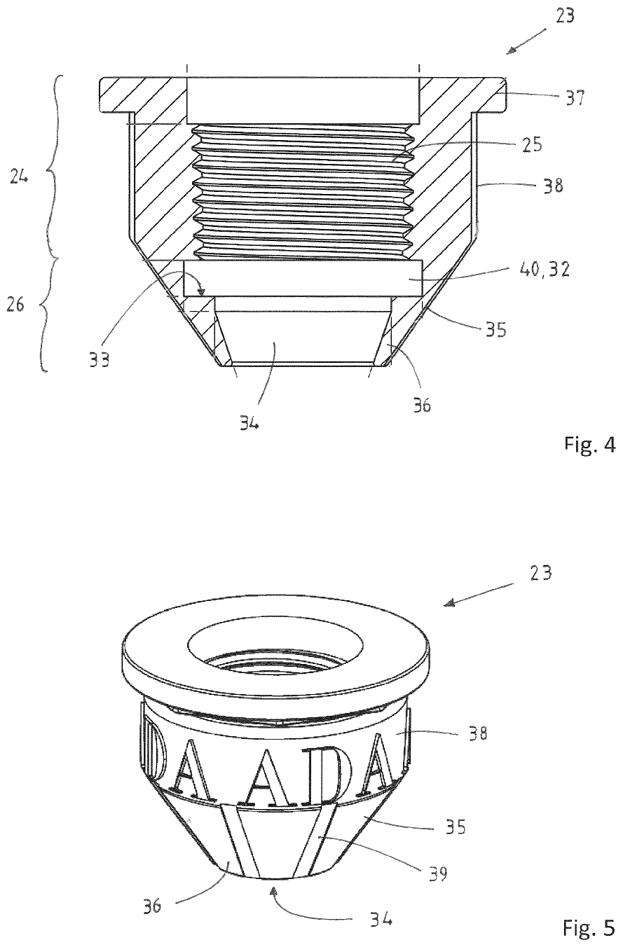

FIG. 4 shows a slightly modified embodiment of a screw sleeve 23, which can in principle be screwed onto the pipe end piece 20 from FIG. 2. The modification compared to the screw sleeve 23 shown in FIG. 2 consists primarily in the fact that the conical surface 35 occupies a larger portion of the axial length of the screw sleeve 23, i.e., the screw sleeve 23 tapers toward the check valve 27 or the central opening 34 starting from its rear region 24, that is to say, even while the internal thread 25 is still located inside it. This is particularly evident from FIG. 5, which is a sectional view of the screw sleeve 23 from FIG. 3.

FIG. 4 is a side sectional view of the screw sleeve 23 from FIG. 2, illustrating several features essential to the invention in the depicted embodiment. These include the rear region 24 of the screw sleeve 23 with the internal thread 25, which is screwed onto the external thread 22 of the pipe end piece 20 (see FIG. 2), and with its cylindrical outer surface 38, which is delimited by the web 37 serving as a stop and by the conical surface 35 serving as an insertion bevel, as well as the front region 26 of the screw sleeve 23 with its central opening 34 for dispensing a liquid product and for inserting a check valve 27 (FIG. 2). The front region 26 of the screw sleeve 23 also forms the tubular collar 36 of the invention for protecting the check valve 27 (not shown in this Figure).

In this embodiment, an annular groove 40 is visible in the front region 26 of the screw sleeve 23, into which the valve base 29 (FIG. 3) is inserted. This annular groove 40 extends toward the central opening 34 into an annular radial stop surface 33, the diameter of which is smaller than the inner diameter of the internal thread 25, so that, when the screw sleeve 23 is screwed on, the annular valve seat 32 is formed between the stop surface 33 and the annular end face 21 of the pipe end piece 20, as shown in FIG. 2. The stop surface 33 can also be regarded as an extension of the groove wall of the annular groove 40.

FIG. 5 illustrates in particular that the screw sleeve 23 is provided on its conical surface 35 with axially extending grooves 39 distributed around its circumference, which extend from the central opening 34 to the cylindrical outer surface 38. The cylindrical outer surface 38 is textured with raised letters (ADAR trademark) so that a bottle neck (not shown) pushed over the conical surface 35 and the outer surface 38 is not accepted with a perfect all-around fit. Rather, the surface textures ensure advantageous pressure equalization when a bottle neck of a dispenser bottle 8 is attached, while the raised letters in particular reliably guide the bottle neck.

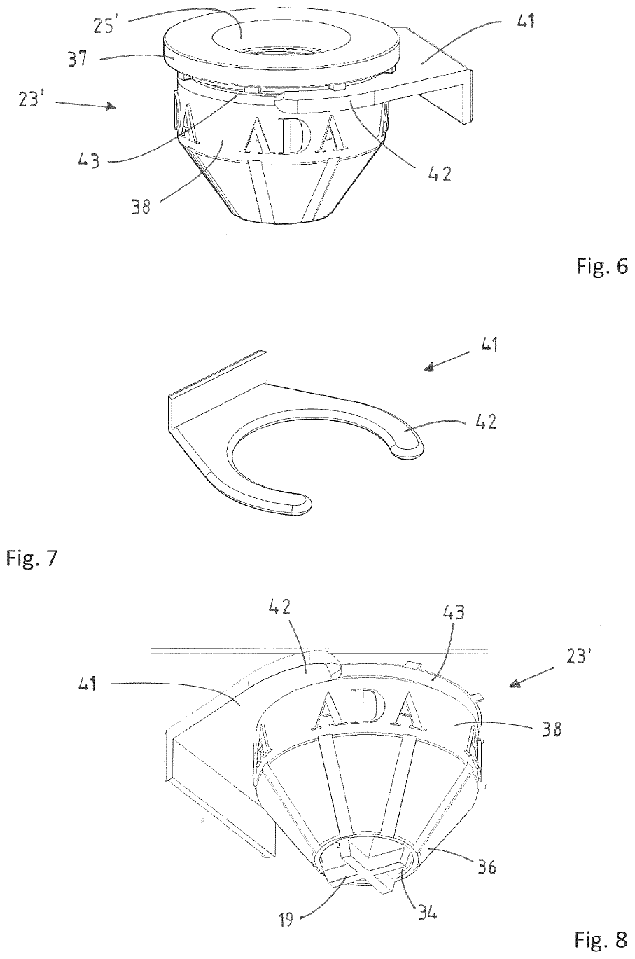

FIGS. 6 to 8 relate to a different embodiment than FIGS. 2 to 5: In this other embodiment, the screw sleeve 23 is replaced by a push-fit sleeve 23′. The push-fit sleeve 23′ differs from the screw sleeve 23 in that its rear cylindrical region 24 does not have an external thread, but rather an inner surface 25′ for proper seating on a mating surface (not shown here) of the pipe end piece 20.

In this embodiment, the push-fit sleeve 23′ is secured to the refilling device or to the pipe end piece 20 by a quick-release fastener 41, which is attached directly to the pipe end piece 20 or next to the pipe end piece 20 on the refilling device. This quick-release fastener 41 is designed to be self-elastic—it is preferably made of plastic-such that it can snap into a circumferential fork receptacle 43 above the cylindrical outer surface 38 using a fork 42. This eliminates the need to unscrew the push-fit sleeve 23′, which further simplifies handling should it become necessary to replace the cross-slot valve 19.

The push-fit sleeve 23′ shown in FIG. 6 also has an annular web 37, like the screw sleeve 23 of the first embodiment. However, its function as a stop surface for a mounted bottle neck is no longer necessary due to the quick-release fastener 41, so that it can just as easily be omitted, as is the case with the push-fit sleeve 23′ in FIG. 8.

FIG. 8 also shows, from a view from below at an angle, how the cross-slotted valve 19 extends through the central opening 34 of the push-fit sleeve 23′ and is simultaneously well protected by the tubular collar 36.

List of reference signs:

| | |
|---|---|
| 1 | Housing |
| 2 | Front side |
| 3 | Projection |
| 4 | Front (of 3) |
| 5 | Underside of 3 |
| 6 | Filling nozzle |
| 7 | Dosing dispenser |
| 8 | Dispenser bottle |
| 9 | Drip tray |
| 10 | Dosing pump (of 7) |
| 11 | Intake pipe (of 7) |
| 12 | Dispensing device (of 7) |
| 13 | Light source |
| 14 | Hinged door |
| 15 | Handle strip |
| 16 | Push button |
| 17 | Rotary control |
| 18 | Maintenance flap |
| 19 | Cross-slot valve |
| 20 | Pipe end piece |
| 21 | End face |
| 22 | External thread |
| 23 | Screw sleeve |
| 24 | Rear region (of 23) |
| 25 | Internal thread |
| 26 | Front region (of 23) |
| 27 | Check valve |
| 28 | Valve body |
| 29 | Valve base |
| 30 | Valve opening |
| 31 | Sealing lip |
| 32 | Valve seat |
| 32 | Stop surface |
| 34 | Central opening |
| 35 | Conical surface |
| 36 | Tubular collar |
| 37 | Annular web |
| 38 | Cylindrical outer surface |
| 39 | Groove |
| 40 | Annular groove |
| 41 | Quick-release fastener |
| 42 | Fork |
| 43 | Fork receptacle |

1. A filling nozzle (6) for a refilling device intended for refilling dosing dispensers (7) for liquid products, the filling nozzle comprising:
a pipe end piece (20) having an annular end face (21) and an external thread (22) or a mating surface (22′);
a screw sleeve (23) or push-fit sleeve (23′) that sits with a rear region (24) axially parallel on the pipe end piece (20), and at least partially covers the end face (21) of the pipe end piece (20) in axial projection with a front region (26) and has a central opening (34) that leaves at least a portion of the pipe cross-section of the pipe end piece (20) free in axial projection;
wherein the screw sleeve (23) is provided in the rear region (24) thereof with an internal thread (25) for screwing onto the external thread (22) of the pipe end piece (20), or the push-fit sleeve (23′) has an inner surface (25′) in the rear region (24′) for fitting onto the mating surface (22′) of the pipe end piece (20);
and the screw sleeve (23) or push-fit sleeve (23′) has an annular groove (40) inside the front region (26) to form a valve seat (32) and/or is provided with an annular radial stop surface surrounding the central opening (34), a diameter of which is smaller than an inner diameter of the internal thread (25) or smaller than an inner diameter of the inner surface (25′), so as to form the valve seat (32) between the stop surface and the annular end face (21) of the pipe end piece (20) when the screw sleeve (23) is screwed on or the push-fit sleeve (23′) is pushed on;
a check valve (27) integrally manufactured from a soft-elastic material and comprising a valve body (28) for closing the pipe end piece (20) and/or the central opening (34) of the screw sleeve (23) or push-fit sleeve (23′), and an annular valve base (29) formed integrally with the valve body (28) and being inserted into the valve seat (32); and
the screw sleeve (23) or push-fit sleeve (23′) extends in the front region (26) thereof into a tubular collar (36) that surrounds at least a major portion of the valve body (28).

2. The refilling nozzle as claimed in claim 1, wherein at least the tubular collar (36) of the screw sleeve (23) or push-fit sleeve (23′) tapers conically at an outer circumference thereof, directed away from the pipe end piece (20).

3. The refilling nozzle as claimed in claim 2, wherein at least the tubular collar (36) is formed as a conical surface (35).

4. The filling nozzle as claimed in claim 2, wherein at least the front region of the screw sleeve (23) or push-fit sleeve (23′) tapers conically along an outer circumference, directed away from the pipe end piece (20).

5. The filling nozzle as claimed in claim 4, wherein at least the front region of the screw sleeve (23) or push-fit sleeve (23′) is formed as a conical surface (35).

6. The filling nozzle as claimed in claim 2, wherein the conically tapered outer circumference of the screw sleeve (23) or push-fit sleeve (23′) forms an insertion bevel complementary to a mandrel for a dosing dispenser (7) to be refilled.

7. The filling nozzle as claimed in claim 6, wherein the insertion bevel is a conical insertion bevel.

8. The refilling nozzle as claimed in claim 2, wherein the rear region (24) of the screw sleeve (23) or push-fit sleeve (23′) forms, at least in partial regions, a cylindrical outer surface (38) adapted for sliding on a dosing dispenser (7) to be refilled.

9. The refilling system as claimed in claim 8, wherein the cylindrical outer surface (38) of the screw sleeve (23) is delimited by an annular web (37) that is configured to act as an end stop for the dosing dispenser (7).

10. The filling nozzle as claimed in claim 8, wherein the conically tapering outer circumference of the screw sleeve (23) or push-fit sleeve (23′) is provided with circumferentially distributed grooves (39) or channels extending substantially in an axial direction.

11. The filling nozzle as claimed in claim 10, wherein the grooves (39) or channels extend into the cylindrical outer surface (38).

12. The filling nozzle as claimed in claim 1, wherein the check valve (27) is made of silicone, LSR silicone rubber, or synthetic rubber.

13. The filling nozzle as claimed in claim 1, wherein the valve body (28) of the check valve (27) has a slot or cross-slot as a valve opening (30) sealed by soft-elastic sealing lips (31), the sealing lips (31) are inclined toward the slot or cross-slot in a direction away from the valve base (29) to allow a liquid product regulated by the check valve (27) to flow out through the slot or cross-slot once a predetermined threshold pressure is reached.

14. The filling nozzle as claimed in claim 1, wherein the check valve (27) is configured as a lip valve, duckbill valve (19), cross-slot valve, dome valve, or silicone cross-slot or cross-cut valve.

15. The filling nozzle as claimed in claim 1, wherein the valve body (28) of the check valve (27) extends on a side thereof facing away from the valve opening into a circumferential, radially outward-facing projection that forms the valve base (29).

16. A refilling device for refilling dosing dispensers for liquid products, comprising the filling nozzle (6) as claimed in claim 1.

17. A refilling system comprising a number of dosing dispensers for liquid products and the refilling device for refilling the dosing dispensers with liquid products, the refilling device comprising the filling nozzle (6) as claimed in claim 1.

18. The refilling system as claimed in claim 17, wherein at least some of the dosing dispensers (7) are provided with refillable dispenser bottles (8), each having a bottle neck with a predetermined inner diameter, and the outer surface (38) of the rear region (24) of the screw sleeve (23) or push-fit sleeve (23′) and the predetermined inner diameter of the bottle neck are matched such that the bottle neck is adapted to be pushed onto the rear region (24) of the screw sleeve (23) or push-fit sleeve (23′), and the outer surface (38) of the rear region (24) of the screw sleeve (23) or push-fit sleeve (23′) guides the neck.
